(19) United States
(12) Patent Application Publication
(10) Pub. No.: US 2009/0197504 A1
(43) Pub. Date: Aug. 6, 2009

(54) Doll with communication function

(75) Inventor: Wei Hsu, Chung Ho City 235 (TW)

Correspondence Address: BACON & THOMAS, PLLC, 625 SLATERS LANE, FOURTH FLOOR, ALEXANDRIA, VA, 22314-1176, US

(73) Assignee: Weistech Technology Co., LTD., Chung Ho City 235 (TW)

(21) Appl. No.: 12/068,381

(22) Filed: Feb. 6, 2008

(51) Int. Cl. A63H 3/28; A63H 3/20; A63H 3/36; A63H 3/38; A63H 5/00; A63F 13/00

(52) U.S. Cl. 446/301; 446/330; 446/390; 446/392; 446/397; 463/1

(57) ABSTRACT

The present invention provides an interactive doll with wireless communication function. The doll with a humanoid figure includes a RF module disposed in the figure. A video input section is disposed in the eye of the figure, and audio output section is disposed in the mouth of the figure.

### FIELD OF THE INVENTION

This invention relates to toys, and more particularly to a doll with communication function.

### DESCRIPTION OF THE PRIOR ART

Figurine, dolls, and similar toys have been used for children as play things. In general, dolls have been used to mimic human or animal entities. In certain case, dolls have been automated, to produce movement and have also included recording devices to produce sounds.

Children, for example, interact with toy cars, tin soldiers, model airplanes, cartoons, stuffed animals and other representative entities, and many if not all of such entities may be shown in some instances with a human personality. There is usual in a child's world, about a talking car. We see such things on television in commercials and cartoons all the time.

The art of fashioning dolls and stuffed animals, such as teddy bears, is very old. Dolls have been found in ancient burial sites and archeological digs, and have served many purposes in the social history of human beings. It is therefore reasonable that as technology of various sorts has developed in human history, the same technology has been applied in unique and often inventive ways to fashioning dolls. For example, as knowledge of human anatomy has developed, dolls with articulated limbs have been developed. Other technology has been applied to produce dolls that walk, talk, cry, drink, urinate, and so forth.

Interactivity between a human and a doll is known in the art as well, as simply as in a doll that makes a noise when it is squeezed or poked, or in dolls that close their eyes when placed in a reclining position and open their eyes when placed again upright.

In the record of development in fashioning dolls, electronics has played an important part. Dolls have been adapted with recording and playback equipment, for example, and with speakers, so dolls so equipped may speak to a child. Dolls have been fitted out with simple robotics devices, and made to crawl or walk. There are many other examples in the art of dolls including electronic gadgets to better simulate human activity and response.

Equipment in such a doll needs to be rugged and durable. Cost is also a factor. Electronic equipment can be quite expensive in the relativity of things that are built into dolls, so there is a tendency to avoid very sophisticated equipment in dolls. Another factor in doll development is the physical space available for electronics. Although some dolls are quite large, most are relatively small, and space for mechanisms and equipment inside a doll is limited.

For these and other reasons, electronic capabilities of dolls has been somewhat limited, so although dolls that speak a number of different phrases or perform a number of different human-like actions may be impressive to many, there is a need for much more capability in dolls.

If a child is limited in cultural interaction until later in childhood than these critical months and years, that child horizons may be severely limited in later years There is a place for a very electronically sophisticated doll in such a scenario as an interactive companion for a child, wherein the doll may have access to substantial knowledge and skill, and also have ability to help a child learn new skills and develop mentally and emotionally healthy associations.

There are many types of children's toys which exhibit some type of interaction to external parameters such as touch or spoken words or sounds from a child user. Such toys appear to interact in some way with the user of the toy, i.e., the child playing with the toy. More sophisticated toys include those which respond to signals transmitted through a television program or a computer terminal so that the toy appears to react to the television program or computer.

However, the prior arts have no any benefit to the communication between the parents and children, therefore, there is a need raised.

### SUMMARY OF THE INVENTION

The object of the present invention is to provide a doll with communication function.

For the aforementioned, the present invention discloses an interactive toy with wireless communication function, comprising: a figure including a replica of a head, a body and limbs; an antenna disposed in the figure; a RF module disposed in the figure and configured to transmit or receive signal via the antenna and through a wireless communication interface; a MPU (microprocessing unit) coupled to the RF module and disposed in the body; a video I/O (input/output) section coupled to the MPU, wherein the video I/O section includes a video input section disposed in the eye of the head, and a video output section disposed in the body; and an audio I/O section coupled to the MPU, wherein the audio I/O section includes a audio input section disposed at the ear of the head, and a audio output section disposed at the mouth of the head.

Moreover, the present invention also discloses an interactive toy with wireless communication function, comprising: a figure including a replica of a head, a body and limbs; an antenna disposed in the figure; a RF module disposed in the figure and configured to transmit or receive signal via the antenna and through a wireless communication interface; a MPU (microprocessing unit) coupled to the RF module; a loudspeaker disposed in the mouth of the head to output the audio component of first signals received via the antenna; a display disposed on the surface of the body and coupled to the MPU to display the video component of the first signals; a camera located in the eye of the head and coupled the MPU, which includes a capture lens and generates video signals from the capture lens; and a microphone disposed in the ear of the head and coupled to the MCU, which receives the audio signals from the external.

### BRIEF DESCRIPTION OF THE DRAWINGS

The foregoing, features and advantage of the present invention will become fully understanding through the detailed description with the accompany drawing:

FIG. 1 is a diagrammatic view illustrating an interactive toy according to the present invention.

FIG. 2 is a block diagram illustrating the system in the interactive toy of FIG. 1 according to the present invention.

FIG. 3 is a diagrammatic view illustrating that a pair of dolls interactively communicate each other according to the present invention.

FIG. 4 is a diagrammatic view illustrating an interactive doll communicating with a computer system via means for the wireless according to the present invention.

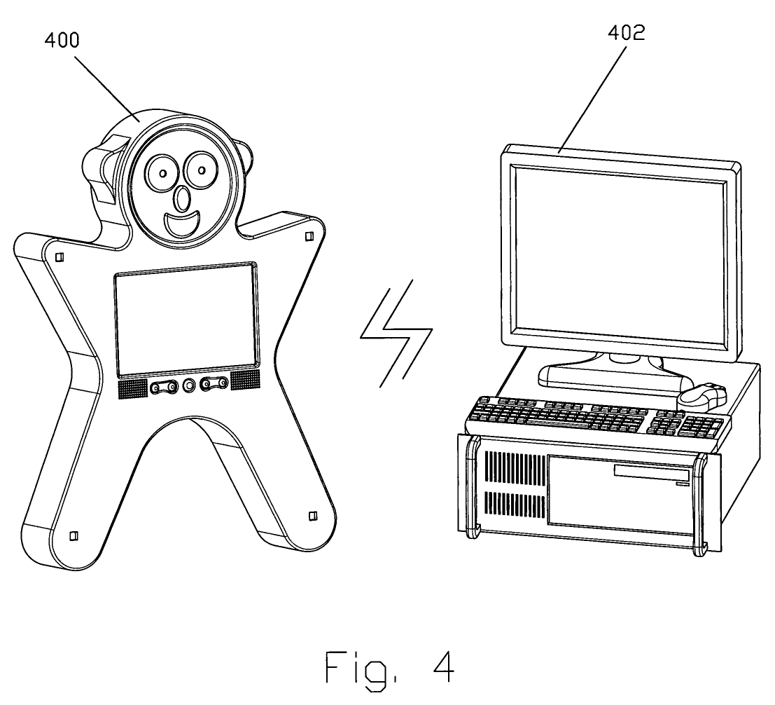

FIG. 5 is a diagrammatic view illustrating an interactive doll communicating with a mobile terminal via means for the wireless according to the present invention.

### DESCRIPTION OF THE PREFERRED EMBODIMENT

The invention will now be described in greater detail with preferred embodiments of the invention and illustrations attached. Nevertheless, it should be recognized that the preferred embodiments of the invention is only for illustrating. Besides the preferred embodiment mentioned here, present invention can be practiced in a wide range of other embodiments besides those explicitly described, and the scope of the present invention is expressly not limited expect as specified in the accompanying Claims.

The present invention relates to an interactive doll with wireless communication. Doll may be made in an image of a human being, such as a baby, a small child, or a young man or woman to mimic human attributes, but the doll is not limited to humanoid shape, extensible to many other articles such as stuffed animals and other toys. Dolls are utilized in practicing the invention in many embodiments, and dolls are used herein for illustrating aspects, features, and characteristics of the invention. A doll is a personal entity with which a child or adult may interact, among a broader class of personal entities.

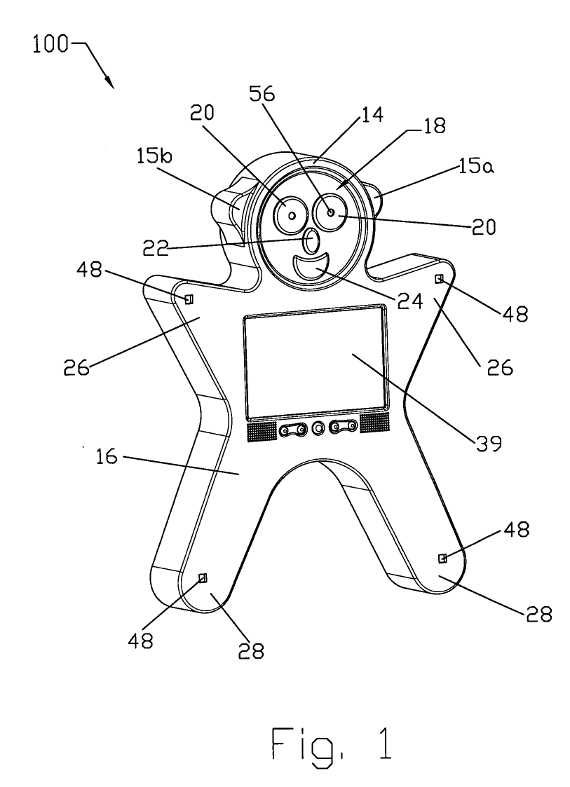

The interactive doll 100 includes a FIG. 12 with a replica of a head 14, a body 16 and limbs shown in FIG. 1. The shape of the doll 100 is not limit to the humanoid, animals or alike type can be applied. The head 14 has a face 18 and a pair of earlike member 15a, 15b. Face 18 shows eyes 20, a nose 22 and a mouth 24. The limbs include arms 26 and legs 28.

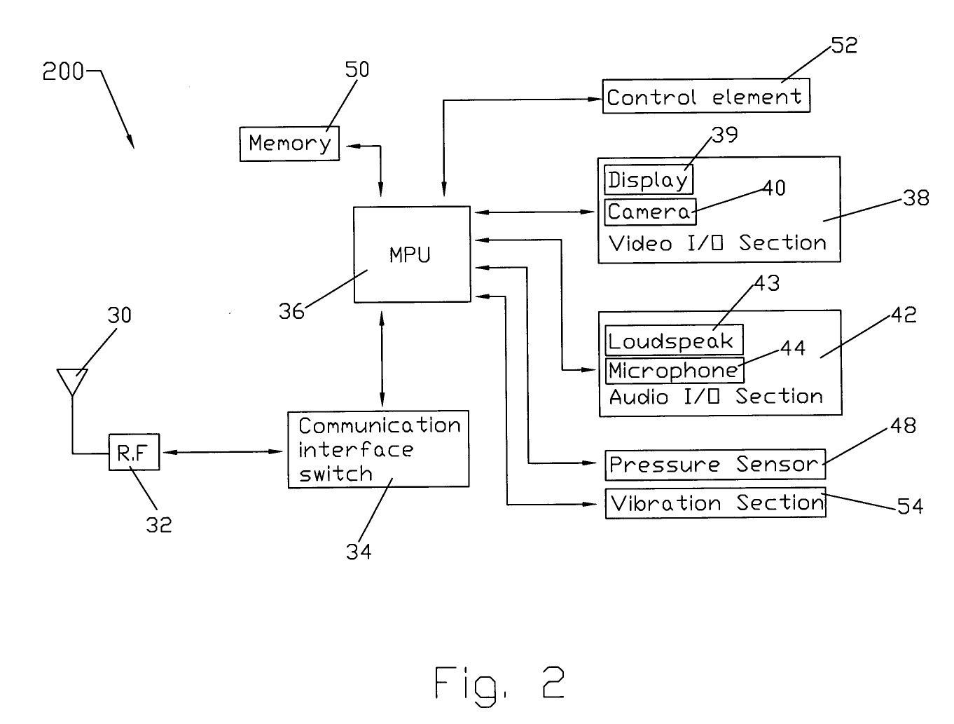

FIG. 2 is a block diagram illustrating the system 200 disposed in the interactive toy 100 of FIG. 1 according to the present invention. The system 200 includes an antenna 30, RF module 32, communication interface switch 34, MPU (micro-processing unit) 36, video I/O (input/output) section 38, audio I/O section 42, and at least one pressure sensor 48 and vibration section 54. Additionally, the system 200 further has a memory 50 and control element 52.

The antenna 30 is coupled to the RF (Radio Frequency) module 32 and disposed in the FIG. 12. The signals are transmitted or received via the antenna 30 by the RF module 32, and typically, the RF module 32 includes a power amplifier, transceiver and synthesizer.

The RF module 32 is configured to transmit or receive signals via the antenna 30 through a wireless communication interface. The communication interface switch 34 is coupled to the RF module 32 and the MCU 36, which changes the wireless communication interface of the system 200 disposed in the interactive toy 100. Preferably, the wireless communication interface includes IrDA (Infrared Data Association), Home RF, Bluetooth, ZigBee, IEEE 802.11, GSM 900, GSM 1800, CDMA, JDC, GPRS, WCDMA or WiMAX, etc.

The MCU 36 is coupled to the video I/O section 38, audio I/O section 42, pressure sensor 48, memory 50, control element 52 and vibration section 54. The video I/O section 38 includes a display 39 (output section) disposed on the surface of the body 16 to display the video component of the signals received via antenna 30, and a camera (input section) 40 with a capture lens to generate video signals from the capture lens. The audio I/O section 42 has a loudspeaker 43 (output section) to output the audio component of the signal received via the antenna 30, and a microphone 44 to receive the audio signals from the external. Preferably, the control element 52 disposed at the body 16 may includes a keyboard or touch panel as an input device.

An emphasis of the present invention is the configuration of the system 200 in interactive doll 100. We intend to show a doll which makes a friendly talk by video telephone. Referring to FIGS. 1 and 2, the camera 40 with the capture lens 56 is disposed in the eyes 20 of the face 18 to mimic humanoid eyes, to generate video signals from the capture lens 56. The loudspeaker 43 is disposed in the mouth 24 of the face 18 and the microphone 44 is disposed in the earlike member 15a or 15b. The pressure sensors 48 and vibration sections 54 are disposed at the limbs with arms 26 and legs 28 to imitate the humanoid touching. When a user X having the same doll uses wireless communication function to contact another one Y having the doll, if the user X touching the place with pressure sensor 48, the user Y can feel the shake of the vibration section 54 in response to the signal received via the antenna 30 from the user X.

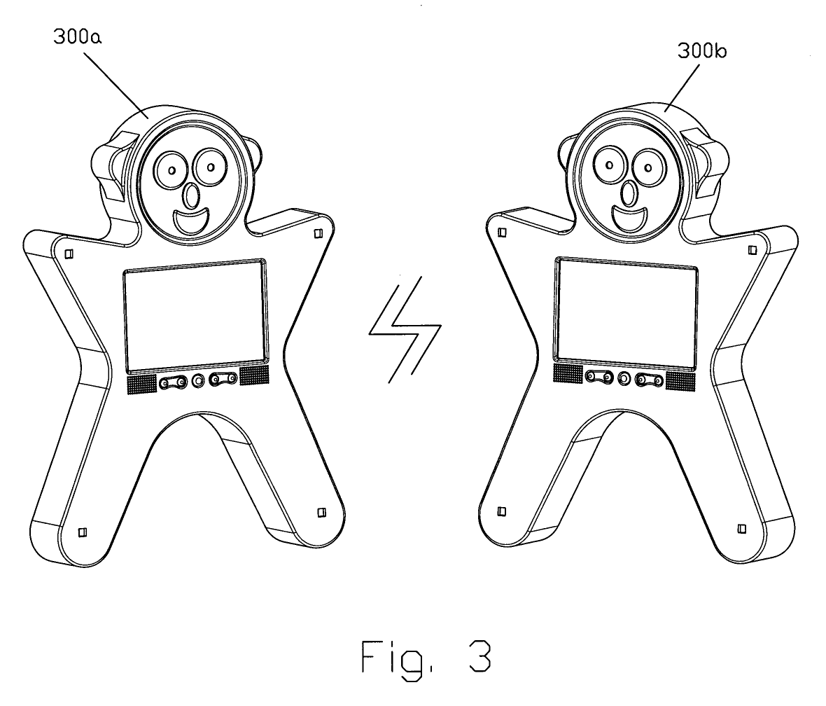

FIG. 3 is a diagrammatic view illustrating that a pair of dolls interactively communicate each other according to the preferred embodiment of the present invention. We use the dolls 300a and 300b having the same structure as the abovementioned doll 100 to illustrate the operation, therefore, the portion of the description similar to FIGS. 1 and 2 isn't repeat.

The communication between the dolls 300a and 300b uses a wireless communication performed. The wireless communication interface can be changed by the communication interface switch, preferably, the wireless communication interface includes IrDA, Home RF, Bluetooth, ZigBee, IEEE 802.11, GSM 900, GSM 1800, CDMA, JDC, GPRS, WCDMA or WiMAX, etc. The interface between the doll 300a and 300b must be identical. The user may utilize the input device, such as keyboard or touch panel to input commands.

In operation, when the signal of the doll 300a is transmitted to the doll 300b by the RF module, the analog signal is received via the antenna of the doll 300b and converted by the A/D converter (not shown) into the digital signal, vice versa. The users of the doll 300a and 300b can communicate with each other by video telephone. The signal consisting of image and voice component of the user can input into the doll through the video and audio input section and be transmitted to the opposite by wireless communication.

For example, the video input section, such as a camera, disposed at the eye of doll 300a may capture the image of the user from the external environment through the capture lens. Alternatively, the voice of the user can be inputted through the microphone disposed in the ears of the doll. The user of the doll 300b can see the image from the display and listen to the voice from the loudspeaker.

Moreover, the user can touch or press the particular place with a pressure sensor, such as the leg or arm of the doll, the message of the touching from the sensor can be transmitted to the opposite doll, and then the vibration section of the opposite doll is operated in response to the received message.

Preferably, the users of the dolls 300a and 300b may be parents and child. The shape of the doll is analogous to a human or animal, the doll with likeable and humanlike appearance can attract the lonely child, and the call is similar to the physically interactive communication to give the lonely child without parents' attention some consolation when the parent communicating with the child through the dolls 300a and 300b. The child saying toward the ear with a microphone is similar to the whisper to the parents, and the feedback talk of the parents broadcasted from the mouth with a loudspeaker is like the parents talk to the child. Furthermore, the child can feel the touch from the parents when the vibration section of the doll is operated in response to the message with the parents pressing or touching the place with the pressure sensor.

In the other preferred embodiment, an interactive doll 400 is communicated with a computer system 402 via means for the wireless according to the present invention. The doll 400 has the same structure as the abovementioned doll 100, therefore, the same portion isn't repeat to statement. In general, the computer system 402 includes a memory, CPU, I/O device, peripheral devices and RF module to perform the wireless communication function.

The communication between the computer system 402 and the doll 400 uses a wireless communication performed. The wireless communication interface can be changed by the communication interface switch, preferably, the wireless communication interface includes IrDA, Home RF, Bluetooth, ZigBee, IEEE 802.11, GSM 900, GSM 1800, CDMA, JDC, GPRS, WCDMA or WiMAX, etc. The interface between the computer system 402 and the doll 400 must be identical.

In operation, the users of the doll 400 and computer system 402 can communicate with each other by video telephone function. The computer system 402 has peripheral device, such as webcam or camera to capture the user's image and transmit to the doll 400 for displaying, and the user of the computer system 402 talks to the opposite one of doll 400 through the microphone configured in the computer system 402.

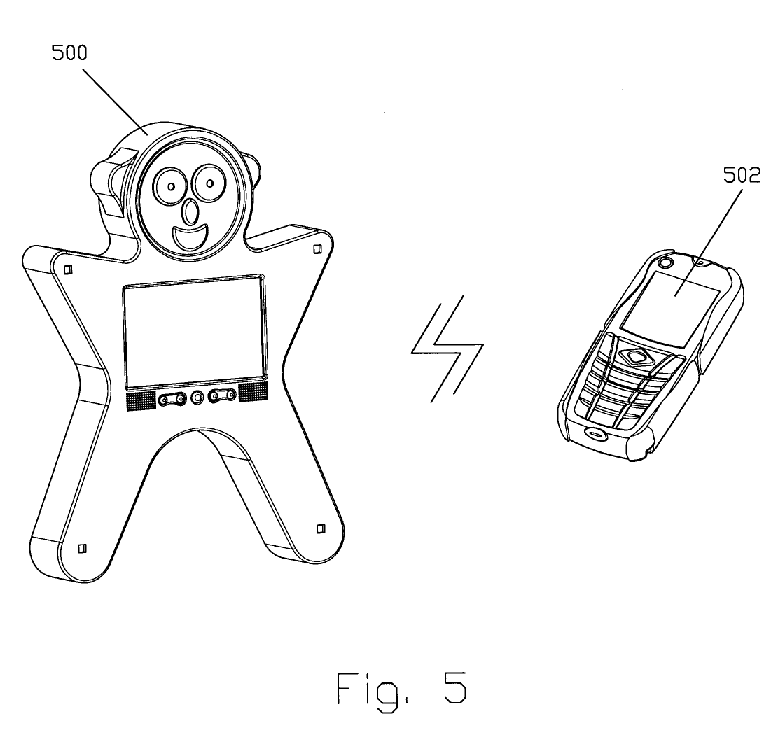

Referring to FIG. 5, an interactive doll 500 is communicated with a mobile terminal 502 via means for the wireless according to another preferred embodiment of the present invention. The doll 500 has the same structure as the abovementioned doll 100, therefore, the same portion isn't repeat to statement. In general, the mobile terminal 502 includes a memory, MPU, I/O device, peripheral devices and RF module to perform the wireless communication function.

The communication between the mobile terminal 502 and the doll 500 uses a wireless communication performed. The wireless communication interface can be changed by the communication interface switch, preferably, the wireless communication interface includes IrDA, Home RF, Bluetooth, ZigBee, IEEE 802.11, GSM 900, GSM 1800, CDMA, JDC, GPRS, WCDMA or WiMAX, etc. The interface between the mobile terminal 502 and the doll 500 must be identical.

In operation, the users of the doll 500 and mobile terminal 502 can communicate with each other by video telephone function. The mobile terminal 502 has peripheral device, such as webcam or camera to capture the user's image and transmit to the doll 500 for displaying, and the user of the mobile terminal 502 talks to the opposite one of doll 400 through the microphone configured in the mobile terminal 502.

The present invention is not limited to dolls, but extensible to many other articles such as stuffed animals and other toys, dolls are utilized in practicing the invention in many embodiments, and dolls are used herein for illustrating aspects, features, and characteristics of the invention. A doll is a personal entity with which a child or adult may interact, among a broader class of personal entities.

Although preferred embodiments of the present invention have been described, it will be understood by those skilled in the art that the present invention should not be limited to the described preferred embodiments. Rather, various changes and modifications can be made within the spirit and scope of the present invention, as defined by the following Claims.

What is claimed is:

1. An interactive toy with wireless communication function, comprising:
a figure including a replica of a head, a body and limbs;
an antenna disposed in said figure;
a RF module disposed in said figure and configured to transmit or receive signal via said antenna and through a wireless communication interface;
a MPU (microprocessing unit) coupled to said RF module;
a loudspeaker disposed in the mouth of said head to output the audio component of first signals received via said antenna;
a display disposed on the surface of said body and coupled to said MPU to display the video component of said first signals;
a camera located in the eye of said head and coupled said MPU, which includes a capture lens and generates video signals from said capture lens; and
a microphone disposed in the ear of said head and coupled to said MCU, which receives the audio signals from the external.

2. The interactive toy of claim 1, further comprising a communication interface switch disposed in said figure and configured to change said communication interface.

3. The interactive toy of claim 1, further comprising at least one pressure sensor disposed at said limbs and coupled to said MPU.

4. The interactive toy of claim 1, further comprising at least one vibration section is disposed at said limbs and coupled to said MPU, wherein said vibration section is operated in response to the signal received via said antenna.

5. The interactive toy of claim 1, further comprising a memory is coupled to said MPU.

6. The interactive toy of claim 1, further comprising a control element is disposed at said body.

7. The interactive toy of claim 6, wherein said control element includes a keyboard or touch panel.

8. The interactive toy of claim 1, wherein said RF module includes a power amplifier, a transceiver and synthesizer.

9. The interactive toy of claim 1, wherein said wireless communication interface includes IrDA (Infrared Data Association), Home RF, Bluetooth, ZigBee, IEEE 802.11, GSM 900, GSM 1800, CDMA, JDC, GPRS, WCDMA or WiMAX communication interface.

10. An interactive toy with wireless communication function, comprising:
a figure including a replica of a head, a body and limbs;
an antenna disposed in said figure;
a RF module disposed in said figure and configured to transmit or receive signal via said antenna and through a wireless communication interface;
a MPU (microprocessing unit) coupled to said RF module and disposed in said body;
a video I/O (input/output) section coupled to said MPU, wherein said video I/O section includes a video input section disposed in the eye of said head, and a video output section disposed in said body; and an audio I/O section coupled to said MPU, wherein said audio I/O section includes a audio input section disposed at the ear of said head, and a audio output section disposed at the mouth of said head.

11. The interactive toy of claim 10, further, further comprising a communication interface switch disposed in said figure and configured to change said communication interface.

12. The interactive toy of claim 10, further comprising at least one pressure sensor disposed at said limbs and coupled to said MCU.

13. The interactive toy of claim 10, further comprising at least one vibration section is disposed at said limbs and coupled to said MCU, wherein said vibration section is operated in response to the signal received via said antenna.

14. The interactive toy of claim 10, further comprising a control element is disposed at said body.

15. The interactive toy of claim 10, wherein said control element includes a keyboard or touch panel.

16. The interactive toy of claim 10, wherein said RF module includes a power amplifier, a transceiver and synthesizer.

17. The interactive toy of claim 10, wherein said wireless communication interface includes IrDA, Home RF, Bluetooth, ZigBee, IEEE 802.11, GSM 900, GSM 1800, CDMA, JDC, GPRS, WCDMA or WiMAX communication interface.

18. The interactive toy of claim 10, wherein said video input section of said video I/O section is a camera which includes a capture lens and generates video signals from said capture lens; wherein said Video output section is a display disposed on the surface of said body to display the video component of said first signals.

19. The interactive toy of claim 10, wherein said audio input section is a microphone which receives the audio signals from the external environment; wherein said audio output section is a loudspeaker to output the audio component of first signals received via said antenna.
